(19) United States
(12) Patent Application Publication
(10) Pub. No.: US 2009/0083275 A1
(43) Pub. Date: Mar. 26, 2009

(54) Method, Apparatus and Computer Program Product for Performing a Visual Search Using Grid-Based Feature Organization

(75) Inventors: Matthias Jacob, London (GB); Wei-Chao Chen, Los Altos, CA (US); Jiang Gao, Sunnyvale, CA (US); Natasha Gelfand, Sunnyvale, CA (US); Radek Grzeszczuk, Menlo Park, CA (US); Kari Pulli, Palo Alto, CA (US); Philipp Schloter, San Francisco, CA (US); Xianglin Wang, Santa Clara, CA (US); Yingen Xiong, Mountain View, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/860,136

(22) Filed: Sep. 24, 2007

(51) Int. Cl. G06F 7/06

(52) U.S. Cl. 707/10; 707/3; 707/E17.014

(57) ABSTRACT

A method, apparatus and computer program product are provided for visually searching feature sets that are organized in a grid-like manner. As such, a feature set associated with a location-based grid area may be received. The location-based grid area may also be associated with the location of a device. After receiving query image features, a visual search may be performed by comparing the query image features with the feature set. The search results are then returned. By conducting the visual search within a feature set that is selected based upon the location of the device, the efficiency of the search can be enhanced and the search may potentially be performed by the device, such as a mobile device, itself.

### TECHNOLOGICAL FIELD

Embodiments of the present invention relate generally to content retrieval technology and, more particularly, relate to a method, apparatus and computer program product for performing a visual search using grid-based feature organization.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to provision of information retrieval in networks. For example, information such as audio, video, image content, text, data, etc., may be made available for retrieval between different entities using various communication networks. Accordingly, devices associated with each of the different entities may be placed in communication with each other to locate and affect a transfer of the information. In particular, mechanisms have been developed to enable devices such as mobile terminals to conduct searches for information or content related to a particular query or keyword.

Text based searches typically involve the use of a search engine that is configured to retrieve results based on query terms inputted by a user. However, due to linguistic challenges such as words having multiple meanings, the quality of search results may not be consistently high. Additionally, performing text based searches on a device encumbered with an inefficient user interface, for example, a conventional mobile terminal, can be cumbersome and problematic.

Given the above described problems associated with text searches, other search types have been popularized. Recently, content based searches are becoming more popular with respect to visual searching. In certain situations, for example, when a user wishes to retrieve image content from a particular location such as a database, the user may wish to review images based on their content. In this regard, for example, the user may wish to review images of cats, animals, cars, etc.

As such, content based visual search functionality has become popular. Visual searches can leverage large visual databases using image matching to compare a query or input image with images in the visual databases. Queries are performed against a database of images, each with associated content that can be displayed when the query image matches on the images in the database. When a matching image is located, related information can be returned as search results. The visual databases used for these searches can be categorized into a form of Augmented Reality (AR). AR is generally thought of as the combination of real world data with computer generated data in a single medium, such as a visual database.

Modern mobile devices hold the promise of making AR practical and universal. First, current mobile devices can be equipped with broadband wireless connectivity giving their users access to vast information of the World Wide Web anywhere and anytime. Second, the need for AR is at its highest in a mobile setting. Third, the physical location of the device can be accurately estimated, through a number of means including GPS and cell tower location triangulation. These features make mobile devices an ideal platform for implementing and deploying AR applications.

A problem arises, however, with visual searches in that, due to the size of visual search databases, searches of the databases can require substantial memory and processing power on the device performing the search in order to provide rapid results. The process of comparing a captured image to all the images in a large database to determine a match can be complex and can often require substantial processing power. Accordingly, the efficiency of a visual search can suffer due to these conditions.

However, visual search queries are often most practical when an individual requesting the visual search is not located proximate to wired devices with substantial memory and processing power. As such, mobile terminal solutions with image capturing technology can provide a platform for performing a visual search. Unfortunately, conventional mobile terminals often do not contain the memory or processing power to perform visual searches on an entire visual database.

Accordingly, it may be advantageous to provide an improved mechanism for performing visual searches in a faster and more efficient manner on a mobile device and/or on a remote server.

### BRIEF SUMMARY

A method, apparatus and computer program product are therefore provided to provide, in some embodiments, for a faster and more efficient mobile visual search. In particular, a method, apparatus and computer program are provided that provide for enhanced visual based searching by focusing the visual search on target portions of the visual search database. In this regard, for example, location-based cells can be defined in the visual search database and features within the database can be parsed into smaller datasets associated with the cells. By constructing the visual search database in this manner, visual searches can use the cell parameter to focus and accordingly expedite a visual search. As such, a visual search can be focused to a particular dataset, rather than querying the entire database. Due to the focused visual search, server based searching can be expedited. Additionally, due to a relatively smaller dataset being targeted in the query, the dataset itself can be transmitted to an electronic device. The electronic device can receive the appropriate dataset by transmitting the device's present location to the server. As such, a mobile device can have the ability to conduct the visual search locally against a smaller received dataset and provide rapid results. Accordingly, the efficiency of search result retrieval can be increased and content management, navigation, tourism, and entertainment functions for electronic devices such as mobile terminals can be improved.

In one embodiment, a method is provided in which a feature set associated with a location-based grid area is received. The location-based grid area may be also associated with the location of a device, such as a mobile device. As such, the received feature set may be updated by receiving features dissimilar from those in a current feature set when the device moves to a different location-based grid. In addition to the feature set, query image features are also received. A visual search is then performed by comparing the query image features with the feature set. In one embodiment, for example, the visual search may be performed using a nearest neighbor search structure which, in turn, includes comparators and feature pointers. Thereafter, the search results may be returned.

As to the feature set, the feature set may be defined in a strategic manner in order to enhance the efficiency of the visual search. In this regard, the feature set of one embodiment may be identified using context, scenario and preference conditions. The feature set may also include location-based groupings of meta-features. In addition, features with less than a specified number of neighbors may be excluded from the feature set. Further, features may be eliminated from memory based upon a feature's distance from the device.

By strategically restricting the size of the feature set that is visually searched, the search may be performed, in some embodiments, by a mobile device. Alternatively, the visual search may be performed by a server with the results returned to the device. Even if the device performs the visual search, the query image features and location information may be transmitted to the server in some circumstances, such as in instances in which the initial search results are inconclusive, in order for the server to perform a visual search against additional features associated with the location-based grid area.

In another embodiment, an apparatus is provided that includes a processor configured to receive a feature set associated with a location-based grid area. The location-based grid area may be also associated with the location of a device, such as a mobile device. In addition to the feature set, the processor is configured to receive query image features. The processor is also configured to perform a visual search by comparing the query image features with the feature set, and to then return the search results.

Alternatively, an apparatus is provided that includes means for receiving a feature set associated with a location-based grid area. The location-based grid area may be also associated with the location of a device, such as a mobile device. The apparatus of this embodiment also includes mean for receiving query image features. Further, the apparatus of this embodiment includes mean for performing a visual search by comparing the query image features with the feature set, and means for returning the search results.

In a further embodiment, a computer program product is provided that has a computer-readable storage medium for storing computer-readable program code portions which include a first executable portion for receiving a feature set associated with a location-based grid area. The location-based grid area may be also associated with the location of a device, such as a mobile device. A second executable portion is also included to receive query image features. The computer program product also includes a third executable portion for performing a visual search by comparing the query image features with the feature set, and a fourth executable portion for returning the search results.

In another aspect of the present invention, a method for constructing a visual search database is provided. This method defines a location-based grid, acquires training images and related information and then associates the training images and related information to a portion of the location-based grid. The method also performs feature extraction, assigns feature robustness values and generates and stores meta-features.

Embodiments of the invention may provide a method, apparatus and computer program product for employment in devices to enhance content retrieval such as by visual searching. As a result, for example, mobile terminals and other electronic devices may benefit from an ability to perform content retrieval in an efficient manner and provide results to the user in an intelligible and useful manner with a reduced reliance upon text entry.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an apparatus for providing a visual search according to an exemplary embodiment of the present invention;

FIG. 4 illustrates an location-based grid according to an exemplary embodiment of the present invention;

FIG. 5 is a flowchart of the operations undertaken to construct a visual search database according to an exemplary embodiment of the present invention;

FIG. 6a is a flowchart of the operations undertaken to perform a visual search according to an exemplary embodiment of the present invention; and

FIG. 6b illustrates an feature storage structure and a search structure for use in a visual search according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

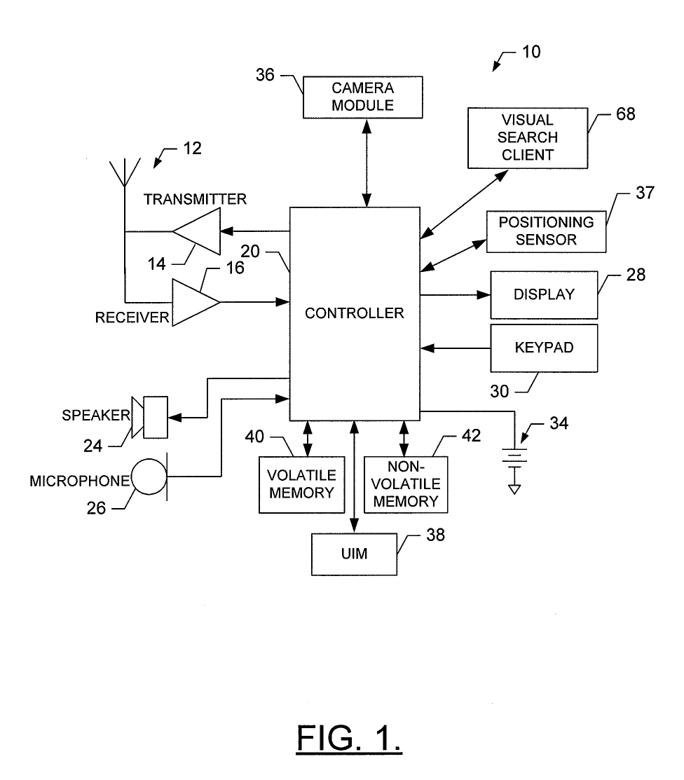

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the apparatus such as the controller 20 includes means, such as circuitry, desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and/or soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

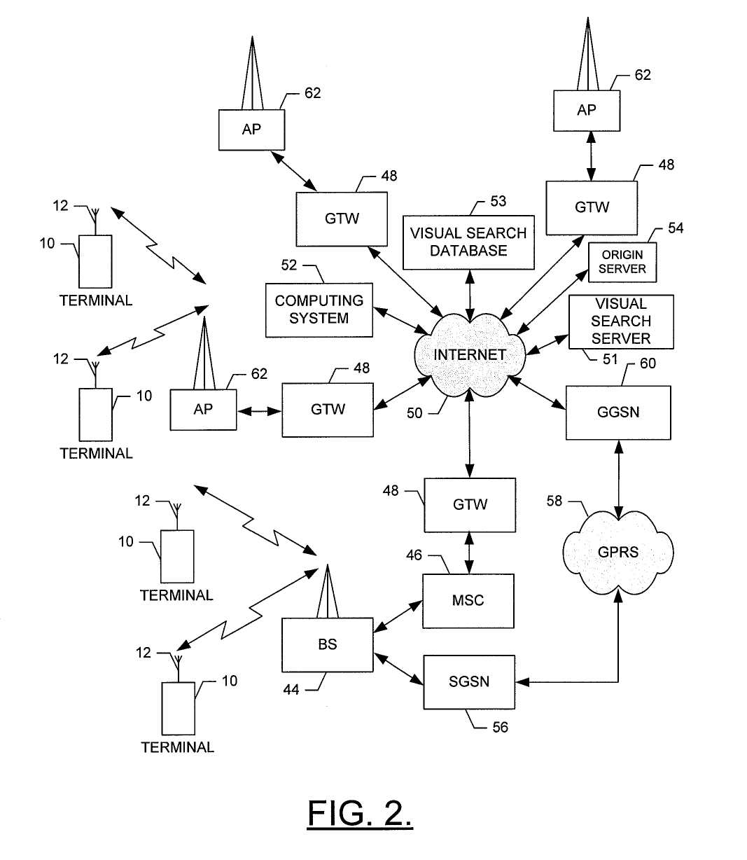

The mobile terminal 10 may further include a positioning sensor 37 such as, for example, a global positioning system (GPS) module in communication with the controller 20. The positioning sensor 37 may be any means, device or circuitry for locating the position of the mobile terminal 10. Additionally, the positioning sensor 37 may be any means for locating the position of a point-of-interest (POI), in images captured by the camera module 36, such as for example, shops, bookstores, restaurants, coffee shops, department stores and other businesses and the like. As such, points-of-interest as used herein may include any entity of interest to a user, such as products and other objects and the like. The positioning sensor 37 may include all hardware for locating the position of a mobile terminal or a POI in an image. Alternatively or additionally, the positioning sensor 37 may utilize a memory device of the mobile terminal 10 to store instructions for execution by the controller 20 in the form of software necessary to determine the position of the mobile terminal or an image of a POI. Although the positioning sensor 37 of this example may be a GPS module, the positioning sensor 37 may include or otherwise alternatively be embodied as, for example, an assisted global positioning system (Assisted-GPS) sensor, or a positioning client, which may be in communication with a network device to receive and/or transmit information for use in determining a position of the mobile terminal 10. In this regard, the position of the mobile terminal 10 may be determined by GPS, as described above, cell ID, signal triangulation, or other mechanisms as well. In one exemplary embodiment, the positioning sensor 37 includes a pedometer or inertial sensor. As such, the positioning sensor 37 may be capable of determining a location of the mobile terminal 10, such as, for example, longitudinal and latitudinal directions of the mobile terminal 10, or a position relative to a reference point such as a destination or start point. Information from the positioning sensor 37 may then be communicated to a memory of the mobile terminal 10 or to another memory device to be stored as a position history or location information. Additionally, the positioning sensor 37 may be capable of utilizing the controller 20 to transmit/receive, via the transmitter 14/receiver 16, locational information such as the position of the mobile terminal 10 and a position of one or more POIs to a server such as, for example, a visual search server 51 and/or a visual search database 53 (see FIG. 2), described more fully below.

The mobile terminal 10 may also include a visual search client 68 (e.g., a unified mobile visual search/mapping client). The visual search client 68 may be any means, device or circuitry embodied in hardware, software, or a combination of hardware and software that is capable of communication with the visual search server 51 and/or the visual search database 53 (see FIG. 2) to process a query (e.g., an image or video clip) received from the camera module 36 for providing results including images having a degree of similarity to the query. For example, the visual search client 68 may be configured for recognizing (either through conducting a visual search based on the query image for similar images within the visual search database 53 or through communicating the query image (raw or compressed), or features of the query image to the visual search server 51 for conducting the visual search and receiving results) objects and/or points-of-interest when the mobile terminal 10 is pointed at the objects and/or POIs or when the objects and/or POIs are in the line of sight of the camera module 36 or when the objects and/or POIs are captured in an image by the camera module 36.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52, origin server 54, the visual search server 51, the visual search database 53, and/or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, visual search server 51, visual search database 53, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or ultra wideband (UWB) techniques such as IEEE 802.15 and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

As will be appreciated, by directly or indirectly connecting the mobile terminals 10 and the computing system 52, the origin server 54, the visual search server 51, the visual search database 53 and/or any of a number of other devices, to the Internet 50, the mobile terminals 10 can communicate with one another, the computing system, 52, the origin server 54, the visual search server 51, the visual search database 53, etc., to thereby carry out various functions of the mobile terminals 10, such as to transmit data, content or the like to, and/or receive content, data or the like from, the computing system 52, the origin server 54, the visual search server 51, and/or the visual search database 53, etc. The visual search server 51, for example, may be embodied as one or more other servers such as, for example, a visual map server that may provide map data relating to a geographical area of one or more mobile terminals 10 or one or more points-of-interest (POI) or a POI server that may store data regarding the geographic location of one or more POI and may store data pertaining to various points-of-interest including but not limited to location of a POI, category of a POI, (e.g., coffee shops or restaurants, sporting venue, concerts, etc.) product information relative to a POI, and the like. Accordingly, for example, the mobile terminal 10 may capture an image or video clip which may be transmitted as a query to the visual search server 51 for use in comparison with images or video clips stored in the visual search database 53. As such, the visual search server 51 may perform comparisons with images or video clips taken by the camera module 36 and determine whether or to what degree these images or video clips are similar to images or video clips stored in the visual search database 53.

Although not shown in FIG. 2, in addition to or in lieu of coupling the mobile terminal 10 to computing systems 52 and/or the visual search server 51 and visual search database 53 across the Internet 50, the mobile terminal 10 and computing system 52 and/or the visual search server 51 and visual search database 53 may be coupled to one another and communicate in accordance with, for example, RF, BT, IrDA or any of a number of different wireline or wireless communication techniques, including LAN, WLAN, WiMAX, UWB techniques and/or the like. One or more of the computing system 52, the visual search server 51 and visual search database 53 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing system 52, the visual search server 51 and the visual search database 53, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

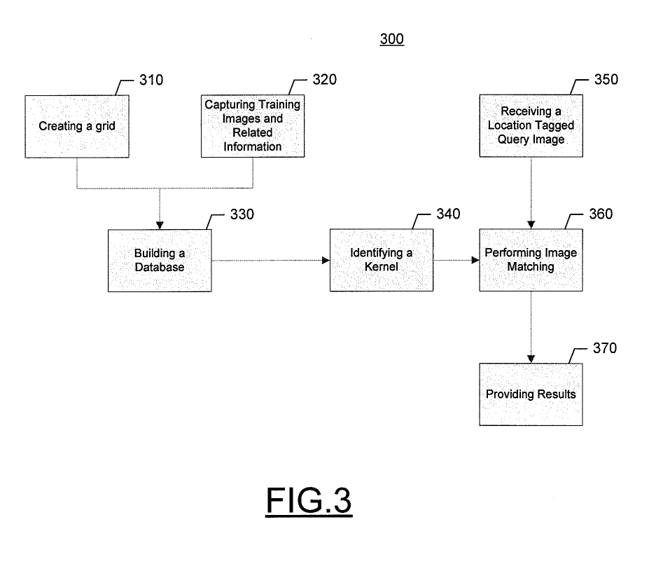

FIG. 3 depicts an exemplary block diagram 300 of an apparatus for performing a visual search according to an exemplary embodiment of the present invention. Block diagram 300 is comprised of operations creating a grid 310, capturing training images and related information 320, building a database 330, identifying a kernel 340, receiving a location tagged query image 350, performing image matching 360, and providing results 370. At operation 310 a grid system can be established to facilitate associations with location tagged training images and associated information, or source information for building the database. At operation 320 training images and related information can be captured. As depicted, associating location tagged training images and related information with a grid facilitates the construction of a visual search database at 330. A location-based subset of the database, or kernel, can be identified at 340. Location tagged query images can be received at 350 and the location tagged query images can be matched against the features associated with kernel 360 at operation 380, performing image matching. Once a match is identified, results of the visual search can be provided at 380. As such, exemplary block diagram 300 depicts an exemplary overview of the present invention.

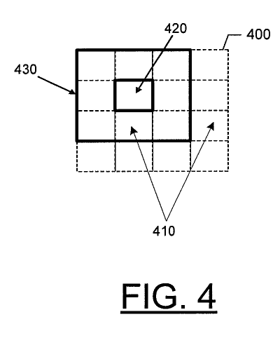

FIG. 4 depicts an exemplary location-based grid 400. The location-based grid 400 is comprised of loxels 410. The location-based grid 400 can be defined using any type of location description information including, but not limited to latitude/longitude, latitude/longitude/altitude triplets, location indicators, or cell IDs. Location-based grid 400 is depicted in FIG. 4 on a two-dimensional plane. However, it is contemplated that location-based grid 400 can be three-dimensional, where the third dimension can be described using, for example, altitude.

Loxels 410 of location-based grid 400 can be described as a fundamental unit area of the location-based grid 400. As used herein, the terms “loxel” and “cell” may be used interchangeably to refer to the fundamental unit area of a location-based grid. In the exemplary location-based grid 400, each loxel is square in shape. However, it is contemplated that loxels may be defined as any shaped area, such as, for example, circular, rectangular, any other polygon shape, or other irregular shape. Further, in some embodiments, loxels can have a flexible radius. Additionally, all loxels need not be the same shape or size. In some embodiments, the size and shape of a loxel may be determined by the quantity of features associated with the particular loxel. As such, the area encompassed in a particular loxel can be dynamically changed as features are added, removed, or compressed within, for example, a visual search database 53. Accordingly, in some embodiments, loxel size can be based upon the density of objects within a particular area. Further, where the location-based grid 400 is three-dimensional, a loxel can be defined by, for example, a three-dimensional polygon. Additionally, image features from an exemplary visual search database can be associated with the loxel where objects depicted in the images are located within the loxel. Such features can be referred to as a loxel feature set.

A kernel, or neighborhood, can be defined as the area that is visible from a particular loxel, coined the kernel's base loxel. In FIG. 4, kernel 430 can be defined by its base loxel 420. In some embodiments, a base loxel is located in the center of its kernel. However, it is contemplated that a base loxel can be located anywhere within a kernel, since a kernel's visual boundary may be non-uniform. Further, the size of a kernel can be limited by the distance at which visual objects are no longer discernible or have a high probability of being occluded. In some exemplary embodiments, since the area size of a kernel is determined by visibility, for a given base loxel, the kernel area can be considered constant. Additionally, in some embodiments, since objects located outside of a kernel may not be visible from the base loxel, images outside the kernel need not be considered when a visual search is conducted. In FIG. 4, the exemplary kernel is defined as the area encompassing the base loxel and the spatially adjacent loxels. However, it is contemplated that the area within a kernel can be any number of shapes and sizes, depending upon the degree of visibility from its base loxel. Accordingly, in some embodiments, kernels can include areas defined by a plurality of loxels or portions of loxels.

In some embodiments, all features associated with objects visible from within a base loxel are associated with a kernel, which can be referred to as the kernel feature set. As such, in some embodiments, a kernel feature set includes all features needed to perform a visual search where a query image was captured from a location within the kernel's base loxel. Accordingly, in some exemplary embodiments, in order to manage the quantity of features contained within a particular kernel, and thus the speed and efficiency of a visual search, the size of a base loxel can be adjusted. A smaller base loxel can result in a smaller kernel, and accordingly less features in a kernel feature set, since less objects are likely visible from a smaller loxel. Similarly, larger base loxels can result in larger kernels, and accordingly increased features within the associated kernel feature set. Changing the area size of a base loxel, and accordingly the size of the kernel feature set, can allow for transmittal of the kernel to, for example, mobile terminal 10, where memory storage capacity may be limited. Thus, in some embodiments, a kernel can define a subset of the features in the exemplary visual search database 53 that are associated with a base loxel, and ultimately the location of an exemplary mobile terminal 10. Further, in some embodiments, a kernel's shape or size can be changed, where the shape or size of the associated base loxel remains fixed.

Additionally, multiple kernels can be associated with a single base loxel when context, scenario, and preference information are considered. Context and scenario conditions such as, but not limited to the time of day, time in a year, current weather conditions, and day-time and night-time conditions can be used to identify an appropriate kernel for a base loxel, given those conditions. Further, preference conditions such as, but not limited to, bandwidth usage, bandwidth availability, memory usage, memory capacity, meeting mode, vacation mode or any other condition that could affect object matching can be used to identify an appropriate kernel for a given base loxel under particular context, scenario, or preference conditions.

Together, the location-based grid 400, loxels 410, and kernels 420 can be used to organize and identify features within a visual search database. As such, the resulting organization can focus visual searches on smaller portions of a larger database. In doing so, the speed and efficiency of visual search functionality can be improved. Further, due to this organization, mobility of the database is feasible, since a small portion of the database can be identified prior to a user's request for a visual search.

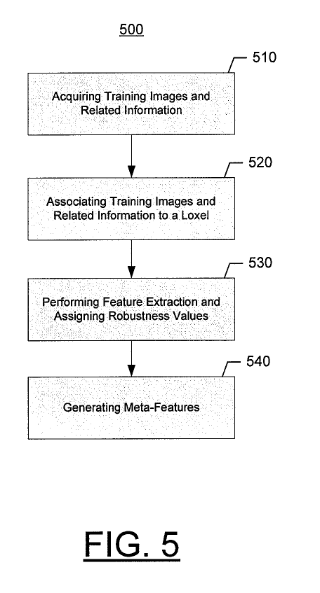

FIG. 5 is a flowchart of a method according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described may be embodied by computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

FIG. 5. depicts a flowchart for a method of constructing a visual search database 500. In some embodiments, the visual search database can be the visual search database 53. The method 500 comprises the operations of acquiring training images and related information 510, associating training images and related information to a loxel 520, performing feature extraction and assigning robustness values 530, and generating meta-features 540. While the operations of method 500 are described in a particular order, differing orders of the operations are contemplated. Further, it is contemplated that some or all of the operations of the method 500 can be performed locally on, for example, a mobile terminal 10, or remotely, for example, on a visual search server 51.

Acquiring training images and related information can be performed at operation 510. Training images and related information can be acquired from any number of sources including but not limited to the internet, visual search query data, proprietary databases, and other electronic or non-electronic sources. For example, location tagged images, e.g., images having associated metadata or other tags that include location information, or images with location information such as those on an associated website, e.g., images that include content that is indicative of a location, can be used as training images and related information. Further, for example, location tagged query images captured by a mobile terminal 10 can be a source of training images and related information. Accordingly, training images and associated information can be gathered from a multitude of sources to be added to, for example, a visual search database 53. As such, in some embodiments, the construction of a visual search database according to method 500 can be a continual process where new location tagged query images or location tagged website images are continually added as training images to the database, and the operations of method 500 are performed on these new training images and related information. Additionally, as each training image is added to the database, the training image can be assigned a unique ID to be used as an index associated with features included in the training image.

Acquiring training images and related information 510, can further comprise a process where training images and related information are clustered together with other training images and related information. A supervised training process can be performed where the training images and related information are clustered based on objects, such as, for example, buildings, commercial establishments, or natural landmarks, that appear in each training image within the cluster. An unsupervised training process can be performed where no object relationships are made, but the training images and related information are clustered according to similarities.

Associating training images and related information to a loxel can be performed at operation 520. Each training image can be tagged with location information, such as metadata containing location information. As such, since loxels can be defined as location-based areas, training images can be associated with loxels through the training image's location information identifying a location within the respective loxel.

Performing feature extraction and assigning robustness values can be performed at operation 530. Training images can be broken down into associated features through a process called feature extraction. Extracted features of images of the same object can be processed and grouped. Common features that correspond to the same object, but are derived under different situations, such as, different viewing angles, distances, and lighting conditions can be grouped. As such, from each image, a set of visual features with respect to viewpoint and illumination changes can be generated that is associated with a particular loxel.

Further, a nearest neighbor search structure can be utilized to determine the robustness of a feature. All of the features associated with a loxel can be inserted into a nearest neighbor search data structure. The nearest neighbor search data structure can be organized in a feature parameter space and can be potentially high dimensional. Accordingly, for each visual feature in a loxel the nearest neighbor search structure can be used to find all features that have values sufficiently close, e.g., within a predefined range, to another feature. This process can be used to determine a feature's neighbors in the nearest neighbor search data structure. As neighbors are identified for a particular feature, a feature counter, or robustness value, can incremented and those features can be grouped together by adding the training image's ID to a list of images associated with the feature. More robust features will have higher counts. In some embodiments, features with particular counts, often low counts, can be avoided in a visual search. In other embodiments, features with particular counts, e.g., counts less than a predefined threshold, may not be included in a kernel feature set, due to a robustness deficiency. However, in some embodiments, features with particular counts can remain stored in the visual search database, leaving open the opportunity that these features may become more robust as features are added to the database.

Generating meta-features can be performed at operation 540. Since a feature counter greater than zero represents several features grouped together, the group of features can be replaced by a meta-feature. The meta-feature can be computed as an average of the grouped features and an associated bounding box. Additionally, an invariant descriptor or value can be determined. In some embodiments, an invariant descriptor or value can be determined by using features of images, such as, for example, edges and corners at different image scales. These features can be used to compute image statistics in the area surrounding the features to determine an invariant descriptor. In some embodiments, for each meta-feature, an invariant descriptor or value, a bounded box, an index of training images associated with or included within the meta-feature, and associated information can be stored. Note that when referring to a visual search process, the term feature and meta-feature may be used interchangeably.

In some embodiments, the database constructed as a result of the operations of method 500 can be stored on a server, such as, for example, visual search server 51. Likewise, when memory limitations permit, in some embodiments, the database constructed as a result of the operations of method 500 can be stored on, for example, mobile terminal 10.

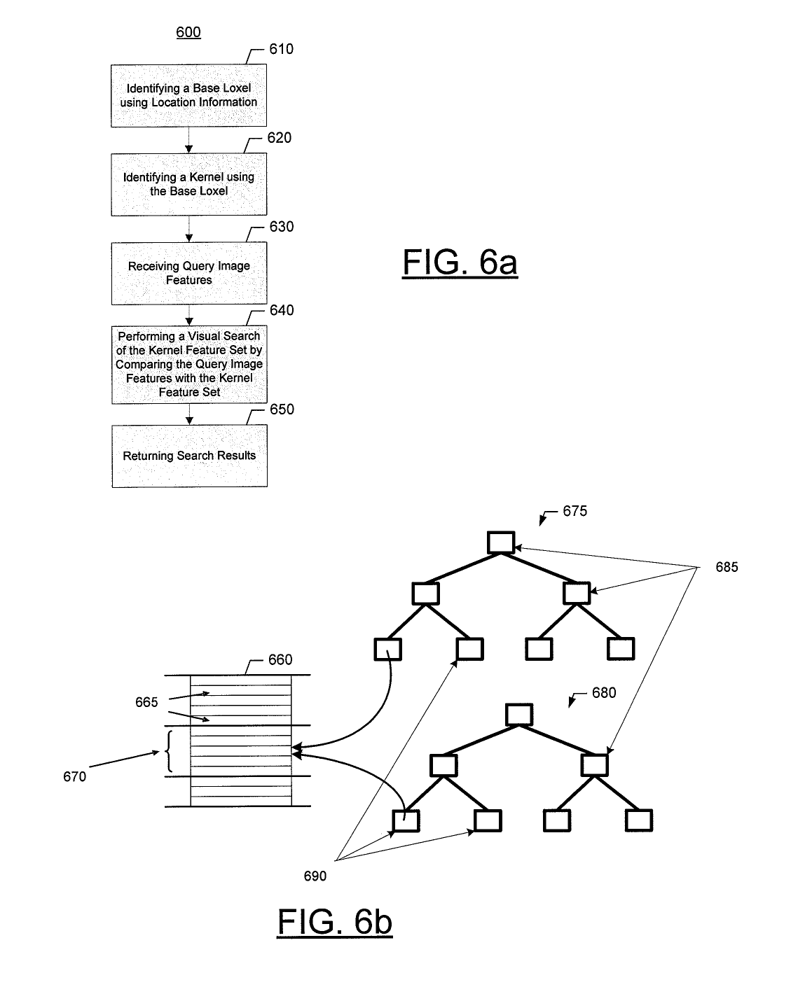

The flowchart of FIG. 6a depicts a method of performing a visual search 600. The method comprises identifying a base loxel using location information 610, identifying a kernel using the base loxel 620, receiving query image features 630, performing a visual search of the kernel feature set by comparing the query image features with the kernel feature set 340, and returning search results 650. While the operations of method 600 are described in a particular order, differing orders of the operations are contemplated. Further, it is contemplated that some or all of the operations of the method 600 can be performed locally on, for example, a mobile terminal 10, or remotely, for example on a visual search server 51.

Identifying a base loxel using location information can be performed at operation 610. Location information can be derived from, for example, the positioning sensor 37 of a mobile terminal 10 that is conducting or requesting the visual search. Location information can be any type of location description information including but not limited to latitude/longitude, latitude/longitude/altitude triplets, location indicators, or cell IDs. Accordingly, using location information, a base loxel can be identified where the location information describes a location within the base loxel. Thus, according to some embodiments of this invention, the location information provided by the positioning sensor 37 of a mobile terminal 10 can be used to determine the base loxel in which a mobile terminal 10 is located.

Identifying a kernel using a base loxel can be performed at operation 620. As discussed above each base loxel has one or more kernels associated with it. In some embodiments, context, scenario and preference conditions can be used to identify an appropriate kernel. Further, in some embodiments, operation 620 can take place by identifying the kernel in an exemplary visual search database 53. In some exemplary embodiments, a mobile terminal 10 can provide location information to a visual search server 51 to determine the appropriate kernel. In other exemplary embodiments, the visual search database may be stored on a mobile device 10 and identification of the kernel can take place on mobile terminal 10.

In some embodiments, operation 620 can comprise receiving a kernel feature set on a mobile terminal 10 from a visual search server 51. The kernel feature set can be continuously updated on, for example, mobile terminal 10 based upon the location of mobile terminal 10. As such, when mobile terminal 10 moves outside of a base loxel, new features can be received by mobile terminal 10 with respect to a new, present base loxel. For instance, if mobile terminal 10 moves outside of a base loxel, a new kernel feature set can be received associated with the present base loxel. Alternatively, since kernel feature sets can be made up of a plurality of loxel feature sets and adjacent kernels are likely to have overlapping loxels contained within them, in some embodiments, only the loxel feature sets that were not part of the past kernel feature set can be received by a mobile terminal 10. In instances in which the visual search database is stored or maintained by a server, either the server can repeatedly poll the mobile terminal for its position or the mobile terminal can repeatedly provide its current position to the server such that the server can determine if the mobile terminal has moved into a different loxel so as to necessitate updating of the kernel feature set. Alternatively, the mobile terminal may have locally stored the bounds of the present base loxel and, as such, may be able to repeatedly compare its current location to the bounds of the present base loxel. If the mobile terminal of this embodiment determines that the mobile terminal has moved into another loxel, the mobile terminal can provide its position or the new base loxel to the server in conjunction with a request for an updated kernel feature set.

Further, since a kernel feature set can be made up a plurality of loxel feature sets, each loxel feature set can be stored as a unit, or feature block, in a feature store. FIG. 6b illustrates an exemplary feature storage structure and a search structure for use in a visual search. FIG. 6b further depicts a feature store 660, features 665, and a feature block 670. In order to facilitate updating of the kernel feature set, newly identified loxel feature sets can be stored as a feature block 670. Features 665 can be stored in the feature store such that the features are high dimensional. In some embodiments, when memory availability is limited, newly identified loxel feature sets can displace existing feature blocks in the feature store when a memory limitation is reached. In some embodiments, when a memory limitation is reached, feature blocks that correspond to loxels that are furthest from the location of, for example, mobile terminal 10, are displaced first. In some embodiments, where memory limitations are not present, loxel feature sets that remain in the feature store can remain in the feature store. Further, in some embodiments, where a particular feature is associated with many kernels, displacement on a feature by feature basis may be practical.

In some embodiments, the process of updating the kernel feature set can occur such that the kernel feature set is received prior to a request to perform a mobile visual search. As such, updating the kernel feature set in this manner facilitates the ability to perform an efficient mobile visual search when the database is too large to be entirely stored on, for example, a mobile terminal 10. Further, in some embodiments, all features required to perform a mobile visual search can be available on an exemplary mobile terminal 10. In embodiments where the kernel feature set is not continuously updated based upon movement, less efficient visual search response can result since the kernel feature set must be updated in response to a request to perform a visual search prior to actually performing the visual search. Additionally, in some embodiments a compression and decompression scheme can be utilized when transmitting and receiving features on an exemplary mobile terminal 10.

Receiving query image features can be performed at operation 630. In some embodiments, camera module 36 of mobile terminal 10 can be used to capture a query image. In some embodiments, a feature extraction can be performed on the query image to generate query image features. Query image features can be stored, for example, in the volatile memory 40 or the non-volatile memory 42 of the mobile terminal 10. In some embodiments, query image features and associated location information can be transmitted to a visual search server 51.

Performing a visual search by comparing the query image features to the kernel feature set, or rather performing feature matching, can be performed at operation 640. In some embodiments, operation 640 can be preformed on a mobile terminal 10 where the kernel feature set is received on mobile terminal 10. In other embodiments, operation 640 can be performed on a visual search server 51.

In some embodiments, a data structure, such as a kernel nearest neighbor search structure, can be generated based on the kernel feature set, and kernel nearest neighbor search structure can be used to facilitate operation 640. The result can be a data structure where features are indexed by location and then searched by feature similarity. FIG. 6b depicts an exemplary embodiment of kernel feature set having two nearest neighbor search sub-structures 675 and 680. The exemplary nearest neighbor search structure, comprised here of two sub-structures 675 and 680, are further comprised of comparators 685 and feature pointers 690. For each query image feature, comparisons can be made at each level of the nearest neighbor search structure between a comparator and a query image feature. In some embodiments, a comparator can sum the differences between the values for each dimension of a feature's descriptor and the value associated with a comparator. In other embodiments, a comparator can sum the squares of the differences in the values for each dimension of a feature's descriptor and the value associated with a comparator. If a feature more closely matches a particular comparator, the process can move to the associated branch of the structure. This process of comparisons continues until the lowest level of the structure is reached, namely the pointers 690. Once a match is determined with respect to a pointer, the pointer will indicate the location of the associated feature in the feature store 660. Further, when a feature match is determined a tally with respect to the stored feature's training images can be kept. After each feature of the query image is matched, the training image with the highest tally is identified using the training image index stored with the features. In some embodiments, where a training image's tally does not reach a set number, the training image can be eliminated from being a potential object match.

By way of example, a query image may include three features designated F1, F2 and F3. Based on the foregoing technique, feature F1 is determined to match with image I1, image I2 and image I3, feature F2 is determined to match with image I2, image I3 and image 14, and feature F3 is determined to match with image I3, image I4 and image I5. As such, the tally, e.g., total number of feature matches, for I1 is 1, for I2 is 2, for I3 is 3, for I4 is 2 and for I5 is 1. If an image must have more than one feature match to be considered a potential match, images I1 and I5 may be eliminated such that images I2, I3 and I4 remain as potential matches with image I3 being the most likely potential match. In some embodiments, the feature match results can be confirmed by considering the spatial relationship of the features in the query image and ensuring that the matched image obeys a similar spatial relationship. Confirming a match in this manner can alleviate issues with noise in images and changes in the appearance of objects within an image.

As such, when all of the query image features are matched, a training image and associated information can be identified. In some embodiments, where the search is performed on a mobile terminal 10 and no match to a training image is obtained, the query image features and location information can be transmitted to a visual database server and feature match can be performed on the server which can include comparisons with features that were not received by the mobile terminal 10, such as, for example, non-robust features. Additionally, in some embodiments, where query image features and the location information are transmitted to a visual search server for comparison, the query image features and the location information can be added to the database through the method 500.

Further, the kernel feature set can be stored in the feature store 660 separately from the kernel nearest neighbor search structure. Storing the kernel feature set and the kernel nearest neighbor search structure separately facilitates updates to the feature store, when, in some embodiments, the kernel feature set and the kernel nearest neighbor search structure are stored on mobile terminal 10. Additionally, when new loxel feature sets are added to the feature store as part of the present kernel feature set, modifications to the kernel's nearest neighbor search structure can be made. In some embodiments, a new kernel nearest neighbor search structure can be received on a mobile terminal 10 with the new kernel feature set or new loxel feature sets as discussed in operation 620. However, in some embodiments, a new kernel nearest neighbor search structure can be generated locally on, for example, mobile terminal 10 using the updated kernel feature set. Further, in other exemplary embodiments, the loxel portion of a nearest neighbor search structure, associated with a new loxel feature set, can be received on a mobile terminal 10. These loxel nearest neighbor search structures can be merged with the existing kernel nearest neighbor search structure on exemplary mobile terminal 10 or remain as separate structures. If a merge process is undertaken, in some embodiments, the loxel nearest neighbor search structures can be simply merged with the existing kernel nearest neighbor search structure, without regard to portions of the kernel nearest neighbor search structure that are no longer contained within the present kernel. Further, the kernel nearest neighbor search structure can be completely rebuilt based on the current kernel feature set, at regular intervals.

Returning search results can be performed at operation 650. Visual search results can be, for example, returned by displaying the results on display 28 of mobile terminal 10. Search results can include, but are not limited to information associated with a matched training image, an associated object, an image, or information associated with an image or object. Additionally, in one embodiment of the invention, search results can be returned by transmitting the results to a mobile terminal 10 from a visual search server 51, and then displaying the results on the display 28 of mobile terminal 10. Further, in some embodiments, where feature matching process identifies an training image from a webpage, the tally from the matching process can be combined with a more general web page importance ranking that analyzes the link structure of the web. As such, relevant web pages according to location and object of interest can be returned.

As noted earlier, it is contemplated that some or all of the elements of method 600 can be performed locally on, for example a mobile terminal 10. Additionally, it is contemplated that some or all of the elements of method 600 can be performed on a server, such as for example, visual search server 51. Further, embodiments of the invention are contemplated where some of the elements of method 600 are performed on, for example, mobile terminal 10 and other elements are performed on, for example, visual search server 51 during a single search.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving a feature set associated with a location-based grid area wherein the location-based grid area is further associated with a location of a device;
receiving query image features;
performing a visual search by comparing the query image features with the feature set; and
returning search results.

2. The method of claim 1, further comprising identifying the feature set using context, scenario and preference conditions.

3. The method of claim 1, wherein the feature set comprises location-based groupings of meta-features.

4. The method of claim 1, wherein the visual search is performed using a nearest neighbor search structure, wherein the nearest neighbor search structure comprises comparators and feature pointers.

5. The method of claim 1, further comprising excluding features with less than a specified number of neighbors from the feature set.

6. The method of claim 1, wherein receiving the feature set comprises updating the feature set by receiving features that are dissimilar from those in a current feature set when the device moves into a different location-based grid area.

7. The method of claim 1, further comprising transmitting the query image features and location information to a server to perform a visual search against additional features associated with the location-based grid area.

8. The method of claim 1, further comprising eliminating features from a memory component based upon a feature's distance from the device.

9. An apparatus comprising a processor configured to:
receive a feature set associated with a location-based grid area wherein the location-based grid area is further associated with a location of a device;
receive query image features;
perform a visual search by comparing the query image features with the feature set; and
return search results.

10. The apparatus of claim 9, wherein the processor is further configured to use context, scenario and preference conditions to identify a feature set.

11. The apparatus of claim 9, wherein the processor is further configured to construct a nearest neighbor search structure using the feature set, wherein the nearest neighbor search structure comprises comparators and feature pointers.

12. The apparatus of claim 9, wherein the processor is further configured to exclude features with a robustness value less than a specified limit from the feature set.

13. The apparatus of claim 9, wherein the processor is further configured to receive feature set updates by receiving features that are dissimilar from those in the current feature set when the device moves into a different location-based grid area.

14. The apparatus of claim 9, wherein the processor is further configured to transmit the query image features and location information to a server to perform a visual search against additional features associated with the location-based grid area.

15. The apparatus of claim 9, further comprising a memory component for storing the feature set, and wherein the processor is further configured to eliminate features from the memory component based upon a feature's distance from the device.

16. A computer program product comprising at least one computer-readable storage medium having computer-readable program code portions stored therein, the computer-readable program code portions comprising:
a first executable portion for receiving a feature set associated with a location-based grid area wherein the location-based rigid area is further associated with a location of a device;
a second executable portion for receiving query image features;
a third executable portion for performing a visual search by comparing the query image features with the feature set; and
a fourth executable portion for returning search results.

17. The computer program product of claim 16, wherein the first executable portion is further configured to identify a feature set using context, scenario and preference conditions.

18. The computer program product of claim 16, wherein the feature set comprises location-based groupings of meta-features.

19. The computer program product of claim 16, wherein the third executable portion is configured to perform a visual search using a nearest neighbor search structure, wherein the nearest neighbor search structure comprises comparators and feature pointers.

20. The computer program product of claim 16, wherein the third executable portion is further configured to exclude features with a robustness value less than a specified limit from the feature set.

21. The computer program product of claim 16, further comprising a fifth executable portion for updating the feature set by receiving features that are dissimilar from those in the current feature set when the device moves into a different location-based grid area.

22. The computer program product of claim 16, further comprising a fifth executable portion for transmitting the query image features and location information to a server to perform a visual search against additional features associated with the location-based grid area.

23. An apparatus comprising:
means for receiving a feature set associated with a location-based grid area wherein the location-based grid area is further associated with a location of a device,
means for receiving query image features;
means for performing a visual search by comparing the query image features with the feature set; and
means for returning search results.

24. The apparatus of claim 23, further comprising means for performing a visual search using a nearest neighbor search structure, wherein the nearest neighbor search structure comprises comparators and feature pointers.

25. A method for constructing a visual search database, the method comprising:
defining a location-based grid,
acquiring training images and related information,
associating the training images and related information to a portion of the location-based grid,
performing feature extraction,
assigning feature robustness values, and
generating and storing meta-features.
